(19) United States
(12) Patent Application Publication
(10) Pub. No.: US 2009/0058067 A1
(43) Pub. Date: Mar. 5, 2009

(54) Devices and Methods for Supporting Printed Mattter

(75) Inventors: Rania Nabil El-Sorrogy, Barrington, IL (US); Rohan Story, Newtown (AU)

Correspondence Address: MOAZZAM & ASSOCIATES, LLC, 7601 LEWINSVILLE ROAD, SUITE 304, MCLEAN, VA, 22102, US

(73) Assignee: Rania, Barrington, IL (US)

(21) Appl. No.: 12/255,582

(22) Filed: Oct. 21, 2008

Related U.S. Application Data
(63) Continuation-in-part of application No. 11/797,100, filed on Apr. 30, 2007.
(60) Provisional application No. 60/796,167, filed on Apr. 28, 2006.

(51) Int. Cl. B42C 13/00

(52) U.S. Cl. 281/21.1; 412/1

(57) ABSTRACT

A book block is contemplated to be bound in its individual sections through various techniques. These sections will be attached to the book cover and/or additional sections by a mechanical way. The user of the book will then be allowed to select and detach individual sections of the book without destroying the integrity of the entire book block. Likewise, publishers of the book are now able to update and/or replace sections of an entire book block without needing to reprint and republish the whole book.

This application is a continuation-in-part of U.S. patent application Ser. No. 11,797,100, filed Apr. 30, 2007, which claims priority to U.S. Provisional Patent Application Ser. No. 60/796,167, filed Apr. 28, 2006, the contents of which are hereby incorporated by reference in their entirety into this disclosure.

### BACKGROUND OF THE INVENTION

1. Field of the Invention

The present invention relates to supporting of printed matter. In particular, the present invention relates to the support of various reading and/or viewing printed material including books, brochures, catalogs and the like.

2. Background of the Invention

As the volume of literature increases, additional costs are associated with the manufacture of printed material, including books, brochures, catalogs, magazines, and the like. Some of this printed matter becomes very large or heavy, particularly because of their tremendous volume or size. Despite the advancement of literature and information, conventional methods of manufacture in the art of bookbinding have been relatively constant and have essentially been limited to (i) case binding and (ii) perfect binding. Traditional Smyth sewn books require a series of arranging, sewing, and gluing steps to adhere signatures (sections of the entire book) to the cover spine. Typically, textbooks and other large-mass books employ the Smyth sewn binding technique.

Perfect bound books mainly require an adhesive binding between the book block and the cover. After the technological booms following World War II, perfect binding became an economical option for many publishers, making it a common practice in contemporary times. Nearly all paperback books, telephone books, and other small-mass books are bound using the perfect binding technique.

Large-mass books are typically perfect bound or bound using the Smyth sewn technique. Many of these large-mass books are published in the form of textbooks or trade books for school students. Such large and heavy books take their toll on those who have to carry these books on a daily or regular basis, typically students. The American Chiropractic Association (ACA) and the American Occupational Therapy Association (AOTA) states that children should not carry more than 10% of their bodyweight. Researchers have found, however, that children are carrying 22% of their bodyweight in studies conducted in the United States.

The National Safety Council states that according to the US Consumer Product Safety Commission there were more than 21,000 backpack related injuries that ended up being treated in emergency rooms, clinics and doctors' offices in 2003. The range of these injuries was widespread from contusions, to sprains, and even fractures.

Some subject matters require new versions of texts in order to account for changes that took place after the initial publication of the book. Using bookbinding methods of the art, the entire text is replaced when revisions are made to a sufficient number of sections. Some fields, such as legal texts, use “pocket parts,” which are smaller independent sections showing only the changes; but the main body of text is unchanged, and both the main body of text and the pocket part must be referenced in order to read the actual updated text. Using existing techniques of the art, there is no other way to replace merely a section of the book.

Thus, there is a need in the art for a more effective technique for manufacturing printed matter such that portions of the printed matter may be carried independently of the other portions, and allowed to be changed, revised or replaced without having to do so for the entire volume in which such portion is a part. The technique should be simple to understand, use and manufacture so that it provides an efficient and less costly alternative to constant volume changes and/or provides an efficient method of carrying just one portion of a large size or volume printed matter.

### SUMMARY OF THE INVENTION

The present invention provides a unique technique of assembling, organizing and/or manufacturing bound or unbound printed matter such that such matter may be easily taken apart into defined portions and each portion carried or reviewed independently of the other. Though examples throughout this application may focus on particular types of printed matter for sake of simplicity, it should be known that the techniques disclosed here are applicable to all types of matter having multiple portions as would be evident to one having ordinary skill in the art after consideration of the present disclosure. Each such portion can also be independently updated or revised without affecting the other portions of the matter that have not been changed. The present invention overcomes many disadvantages associated with conventional bookbinding and manufacturing techniques by using a novel and simple technique of combining interlocking components that comprise sections of a reading material, such as a book. Book users need not transport the entirety of a book when they only desire to focus on one chapter or section of the book. With the present invention, the book user can select the portion(s) of the book she would like to carry with her. Likewise, book publishers need not reprint the entirety of a book when they desire to alter select chapters or sections of the book. With the present invention, the book publisher can select portion(s) of the book that it would like to update, reprint, and sell. Such technique is more advantageous to the publisher, because only certain portions of a, for example, textbook are revised and the cost of printing is limited to those particular portions, such as a chapter. That individual portion can then be sold at a substantially reduced rate than having to reprint and sell the entire textbook. Such high costs of having to re-publish an entire book also prevent many buyers from purchasing new versions because of the lack of substantial difference from older versions of the same textbook. Thus, with the present technique, the publishers can realize higher sales of relevant portions of a textbook because consumers are more apt to purchase those portions of a textbook that are updated rather than an entirely reprinted new textbook.

Using techniques presented herein and according to the present invention, portions or sections of a book will be individually bound, such as, but not limited to, a perfect binding method. These smaller sections of the whole textbook could be gathered under a book cover. The force used for attraction between the sections and the book cover would be strong enough to keep the entire book block together, when this is the desired use. The sections can also be detached from the book cover and carried separately. A few examples of forces used for attaching the detachable sections include magnetic and mechanical techniques.

For sake of simplicity, exemplary techniques that may be used in conjunction with the present invention have been presented in various groups of embodiments. Also, for sake of simplicity, the various embodiments are presented with use of a “book” for sake of simplicity. However, the present invention and techniques are equally applicable to other forms of printed and bound and unbound matter, including but not limited to, magazines, directories, newspapers, brochures, photographic albums, and the like. In a non-limiting example of unbound material, techniques disclosed in the present invention may be used to assemble previously unbound materials into a cohesive unit, as well as serving as binding for different sections of the unbound printed matter. One of ordinary skill in the art would be cognizant of these and other type of printed or photographic matter that could be used by the techniques presented in the present disclosure. All such uses are within the scope of the present invention.

The mechanical embodiments explained in the present invention provide mechanical methods of fastening the sections to the book cover or fastening the book sections to one another. Examples of mechanically-attaching mechanisms include but are not limited to a series of interlocking convexities and concavities, such as a tongue and groove mechanism. Many other mechanical binding devices may be used and such other devices are apparent to one having ordinary skill in the art and thereby within the scope of the present invention.

The sections (or chapters) of a sectional book constructed using the mechanical method can be mechanically-adhered to the book cover or each other, so that each section may be independently separated from the entire book block. Thus, sections of the book can be individually bound, and the book cover and/or section covers can include at least one mechanically-attaching member.

The present invention has many uses and advantages as would be apparent to one having ordinary skill in the art after consideration of the present disclosure. Exemplary non-limiting uses and advantages over conventional techniques include, but are not limited to: providing a convenient way for users to select which portions of a book to carry with them; providing a reduction in overall weight carried by the user in the forms of books; providing a way for reducing back-related injuries due to carrying heavy books; providing book publishers a way to update portions of the book without need to reprint the entire book; providing book publishers a way to reduce their overall cost of production for new and/or updated versions of books.

### BRIEF DESCRIPTION OF THE DRAWINGS

FIG. 1A shows a perspective view of a tongue and groove mechanism between section members and book cover, with at least one flexible convexity (tongue) along the section member's spine and at least one complimentary durable concavity (groove) along the book cover, according to an exemplary embodiment of the present invention.

FIG. 1B shows an end view of FIG. 1A.

FIG. 2A shows a perspective view of an alternative version of a tongue and groove mechanism between section members and book cover, with at least one flexible concavity (groove) along the section member's spine and at least one complimentary durable convexity (tongue) along the book cover, according to an exemplary embodiment of the present invention.

FIG. 2B shows an end view of FIG. 2A.

FIG. 3 shows an end view of a tongue and groove mechanism between section members, according to an exemplary embodiment of the present invention.

FIG. 4 shows an alternative tongue and groove mechanism between section members wherein at least one material addition is attached along the spine of the section members, and complimentary tongue and groove elements are attached along opposite sides of this material addition, such that it has at least one concavity along the surface of one end and at least one complimentary convexity along the surface of the other end, according to an exemplary embodiment of the present invention.

FIG. 5 shows various convex (tongue) attaching members, according to exemplary embodiments of the present invention.

FIG. 6 shows various complimentary concave (groove) attaching members, according to exemplary embodiments of the present invention.

FIG. 7A shows a perspective view of an enforced tension-release groove mechanism between section members and book cover, with at least one durable convexity (tongue) along the section member's spine and at least one complimentary flexible concavity (groove) along the book cover, according to an exemplary embodiment of the present invention.

FIG. 7B shows and end view of FIG. 7A.

FIG. 7C depicts enlarged view of FIG. 7B, with a focus on the connecting mechanism between section member and book cover.

FIG. 8A shows a perspective view of an alternative version of an enforced tension-release groove mechanism between section members and book cover, with at least one flexible concavity (groove) along the section member's spine and at least one complimentary durable convexity (tongue) along the book cover, according to an exemplary embodiment of the present invention.

FIG. 8B shows an end view of FIG. 8A.

FIG. 8C depicts enlarged view of FIG. 8B, with a focus on the connecting mechanism between section member and book cover.

FIG. 9 shows a perspective view of an alternative tension-release groove mechanism between section members, according to an exemplary embodiment of the present invention.

FIG. 10 shows an alternative tension-release groove mechanism between section members wherein at least one material addition is attached along the spine of the section members and complimentary tongue and groove elements are attached along opposite sides of this material addition, such that it has at least one concavity along the surface of one end and at least one complimentary convexity along the surface of the other end, according to an exemplary embodiment of the present invention.

### DETAILED DESCRIPTION OF THE INVENTION

As disclosed in the present description and accompanying drawings, the present invention provides for manufacture, sale, and use of a printed matter incorporating reversibly detachable sections.

To assist in the consideration of the present disclosure and accompanying drawings, the following labels have been used and are generally presented here and described in more detail below:

10: Book cover

15: Spine region of book cover

21 A, B: Convex tongue attaching member

22 A, B: Complimentary concave groove attaching member

23: Convex tongue attaching member with stopper element

24: Complimentary concave groove attaching member with stopper element

26: Complimentary concave groove attaching member with stopper element containing unique tension element

30 A, B: Section member

35 A, B: Spine region of section member

37 A, B: Alternative spine region of section member

41 A, B: Alternative durable linear rod

42 A, B: Alternative complimentary enforced tension-release groove

The following is a non-limiting list of exemplary mechanical embodiments of the present invention. The section members 30A and 30B can be attached to the book cover 10 through adjoining members. Section members 30A and 30B can also be attached to each other. Combinations of attaching the section member 30A and/or 30B and book cover 10 by adjoining members include but are not limited to (i) tongue-groove, (ii) groove-tongue, (iii) tension-release, (iv) enforced tension-release, (v) interlocking hinge mechanisms. Combinations of attaching the section member 30A to 30B by adjoining members include but are not limited to (i) tongue-groove, (ii) groove-tongue, (iii) tension-release, (iv) enforced tension-release, (v) interlocking hinge mechanisms.

The attaching members of these embodiments are made of flexible and durable materials (such as plastic and/or rubber and/or metal), which would be affixed to the book cover and/or section member(s). These members may be affixed in a variety of permanent or non-permanent ways, such as gluing, taping, sewing, clasping, crimping, or interlocking. Thus, the attaching mechanism may be reversible or irreversible, depending on the desire of the user. The most likely method for affixing members described in the tongue and groove embodiments is gluing, while the tension snapping embodiments may require additional strength by employing additional sewing and/or crimping. The composition base of the adhesive used to affix attaching members to the book cover and/or section members may include but is not limited to a polyvinyl acetate (PVA), resin, ground animal, ground hide, liquid hide, or caoutchouc (raw rubber).

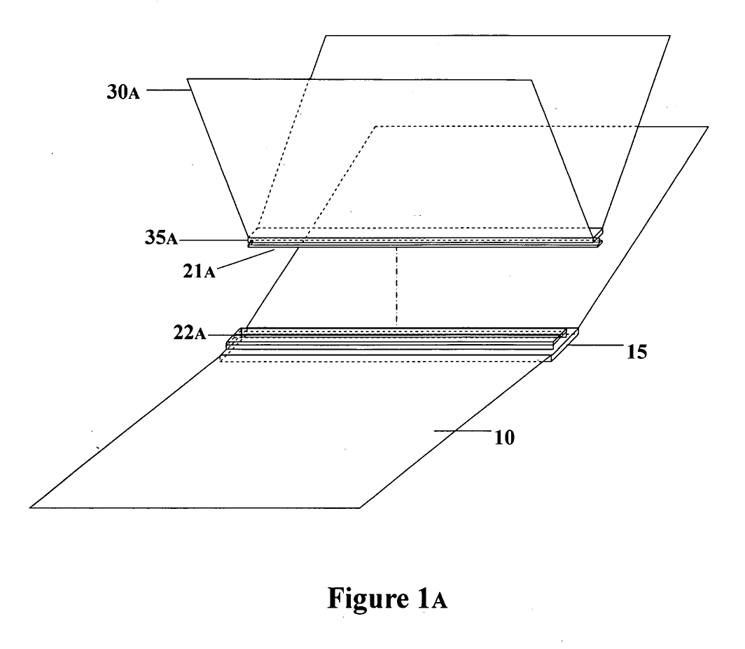

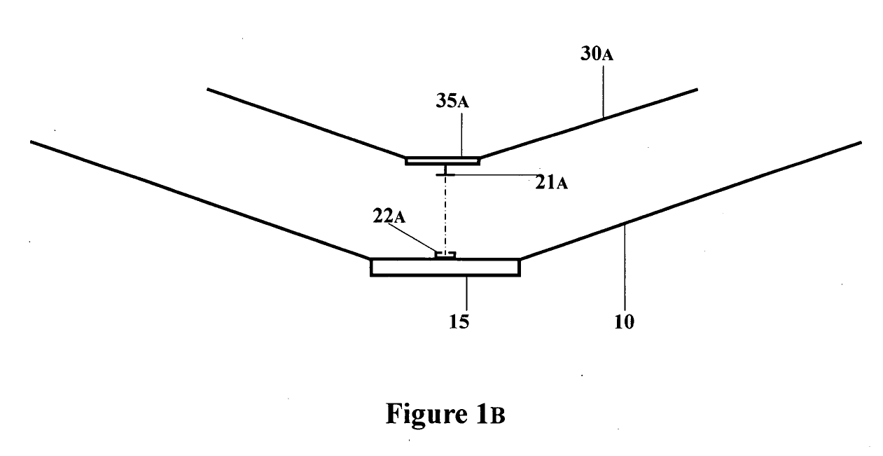

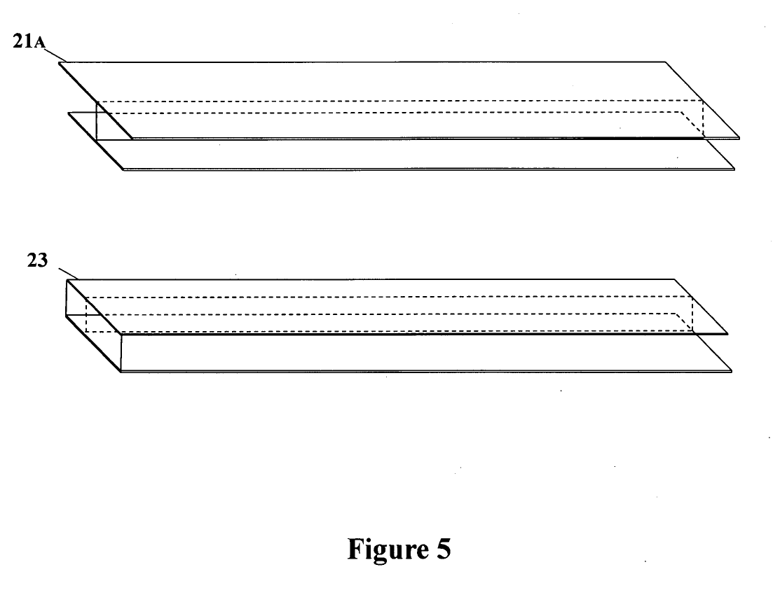

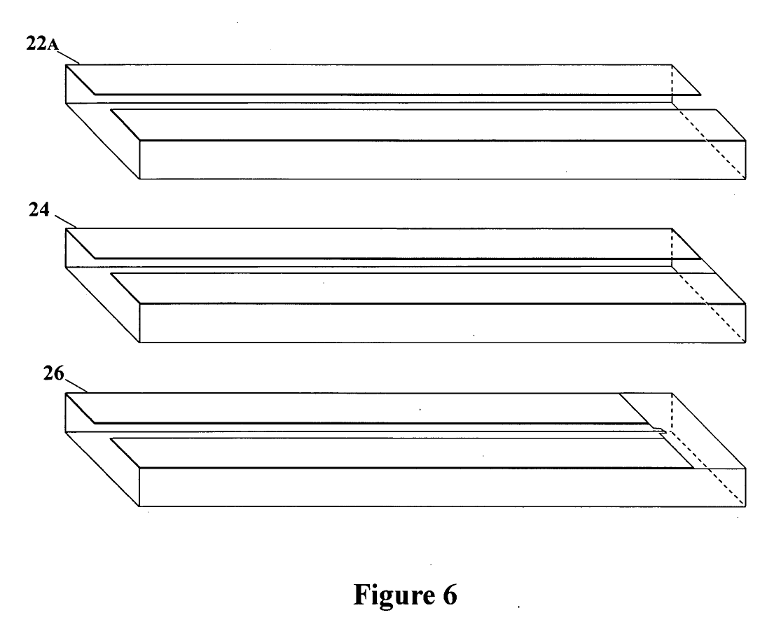

FIGS. 1A and 1B depict a tongue and groove mechanism between book cover 10 and section member 30A. In this embodiment, there is a unique convexity 21A along the exterior of the spine region 35A of the section member 30A. A complimentary concavity 22A is placed along the interior of the spine region 15 of the book cover 10. This arrangement of complimentary concavity and convexity will allow the section member 30A to attach and be retained by the book cover 10 by inserting and/or sliding unique convexity 21A into the complimentary unique concavity 22A. The alternative unique concavities and complimentary convexities described in FIG. 5 and FIG. 6 are may also be arranged in similar fashions as this embodiment.

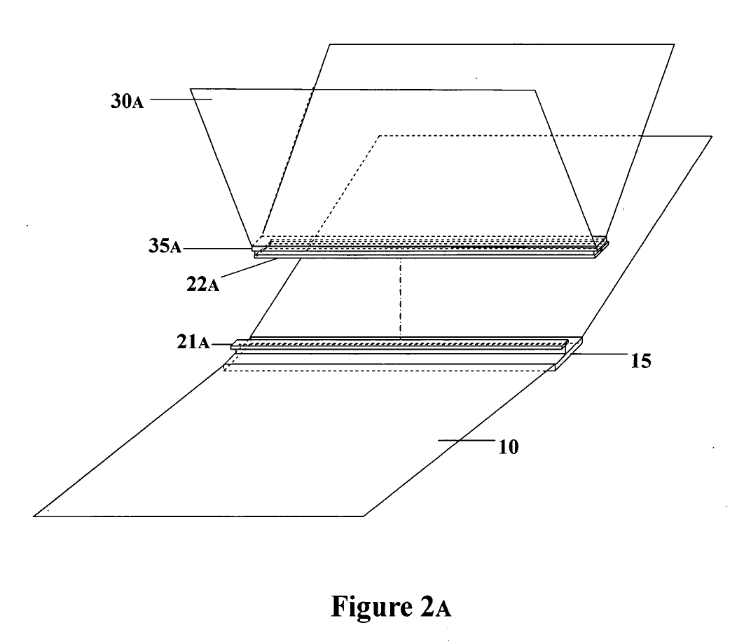

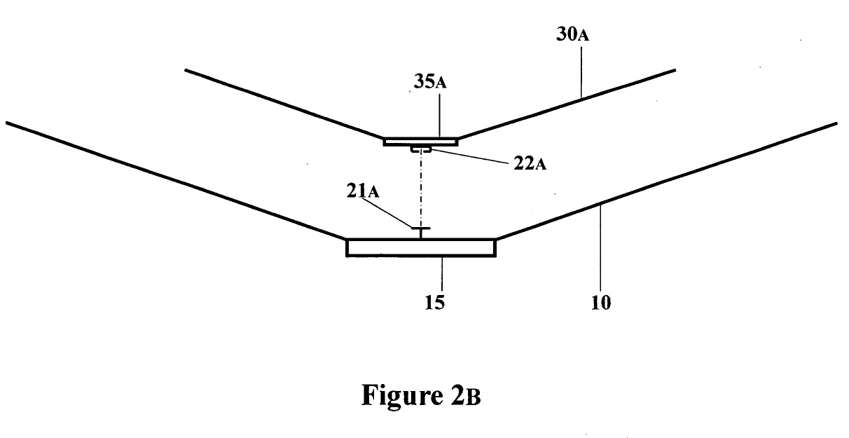

FIGS. 2A and 2B depict another tongue and groove mechanism between book cover 10 and section member 30A. In this embodiment, there is a unique concavity 22A along the exterior of the spine region 35A of the section member 30A. A complimentary convexity 21A is placed along the interior of the spine region 15 of the book cover 10. This arrangement of complimentary concavity and convexity will allow the section member 30A to attach and be retained by the book cover 10 by inserting and/or sliding unique convexity 21A into the complimentary unique concavity 22A. The alternative unique concavities and complimentary convexities described in FIG. 5 and FIG. 6 are may also be arranged in similar fashions as this embodiment, as examples of alternative exemplary embodiments of the present invention.

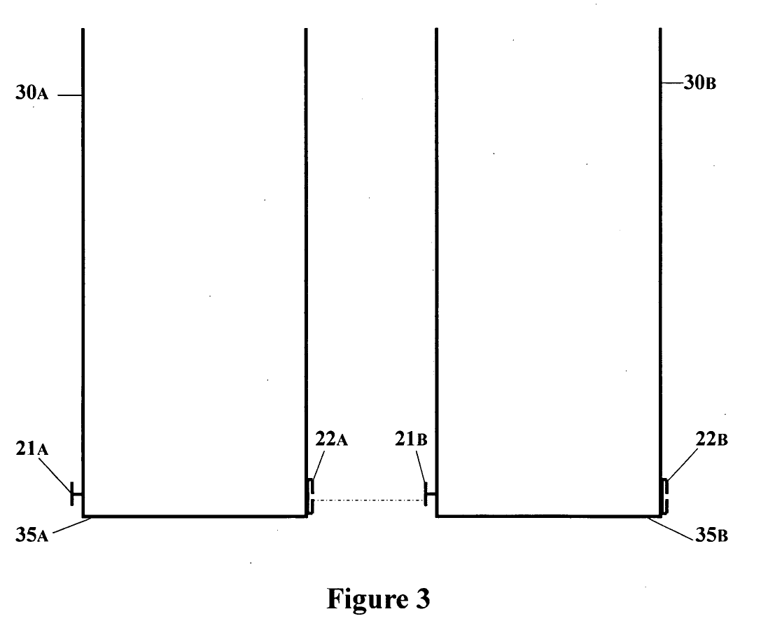

FIG. 3 depicts a tongue and groove mechanism between section member 30A and section member 30B. Unique convexities 21A and 21B compliment the unique concavities 22A and 22B. In this embodiment, convexity 21B and concavity 22B are located along parallel planes of section member 30B near the spine region 35B of section member 30B. In this embodiment, convexity 21A and concavity 22A are located along parallel planes of section member 30A near the spine region 35A of section member 30A. This arrangement will allow the section member 30A to attach to section member 30B by inserting and/or sliding unique convexity 21B into the complimentary unique concavity 22A.

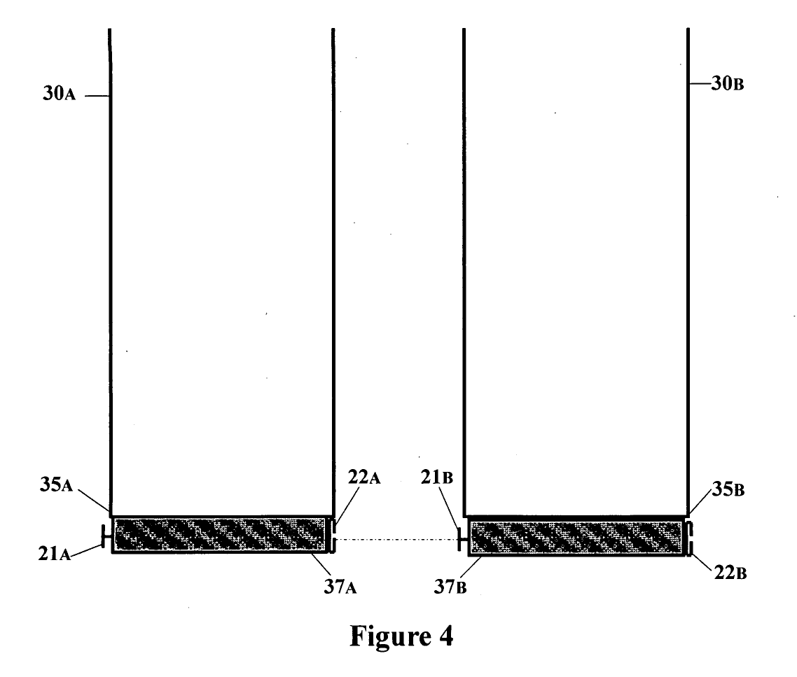

FIG. 4 depicts an alternative tongue and groove mechanism between section member 30A and section member 30B, utilizing affixed elements 37A and 37B. Unique convexities 21A and 21B compliment the unique concavities 22A and 22B. In this embodiment, convexity 21B and concavity 22B are located on parallel planes of element 37B near the spine region 35B of section member 30B. In this embodiment, convexity 21A and concavity 22A are located on parallel planes of element 37A near the spine region 35A of section member 30A. This arrangement will allow the section member 30A to attach to section member 30B by inserting and/or unique convexity 21B into the complimentary unique concavity 22A.

FIG. 5 shows examples of unique convexities for the tongue and groove mechanisms. Unique convexity 21A depicts a tongue member comprised of a durable supporting column between an upper and lower plane of material. Unique convexity 23 depicts an alternative tongue member with a solid material along one end of its horizontal plane, which effectively secures and stops continuous sliding movement within its complimentary unique concavity. These attaching members may be placed along or near the spine areas 35A, 35B of section members 30A, 30B, respectively and/or along the interior of the spine region 10 of book cover 15, for the described tongue and groove mechanisms.

FIG. 6 shows examples of unique concavities for the tongue and groove mechanisms. Unique concavity 22A depicts a groove member comprised of two supporting members parallel to and along the ends of an upper and lower plane of material, effectively creating a void between upper and lower bounds. This lower plane of material is solid, while this upper plane of material has at least one linear void or opening that runs parallel to the length of the groove. Unique concavity 24 depicts an alternative groove member with a solid material along one end of its horizontal plane, which effectively secures and stops continuous sliding movement within its complimentary unique concavity. Unique concavity 26 depicts another alternative groove member that includes a slightly narrower groove opening along at least one plane of the upper and lower planes of the groove. This narrow opening applies tension to the supporting beam of its complimentary unique convexity, effectively retaining the tongue member and the section member or book cover to which the complimentary unique concavity is attached. These attaching members may be placed along or near the spine areas 35A, 35B of section members 30A, 30B, respectively and/or along the interior of the spine region 10 of book cover 15, for the described interlocking groove mechanisms.

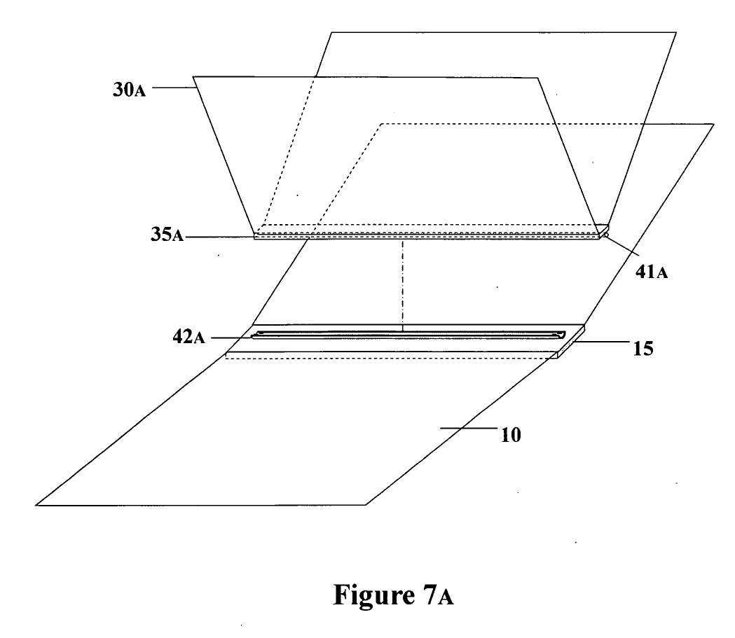

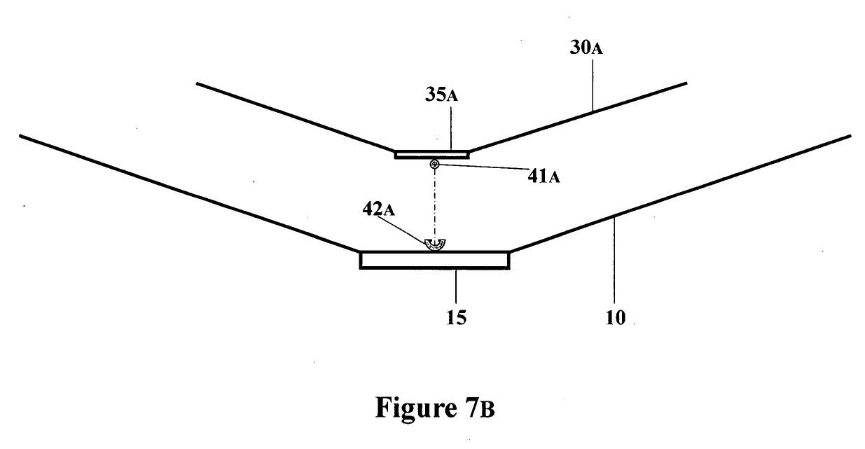

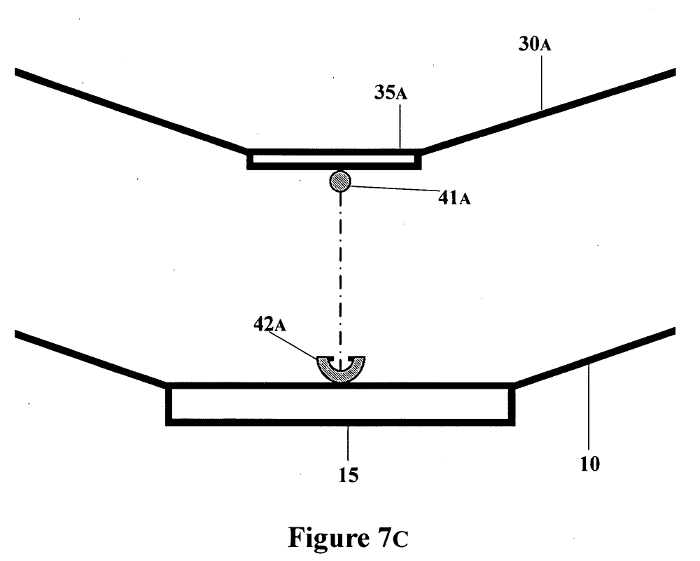

FIGS. 7A, 7B, and 7C depict an enforced tension groove mechanism between book cover 10 and section member 30A. In this embodiment, there is a unique convexity 41A along the exterior of the spine region 35A of the section member 30A. A complimentary concavity 42A is placed along the interior of the spine region 15 of the book cover 10. This arrangement will allow the section member 30A to attach to book cover 10 by applying force and inserting unique convexity 41A into the complimentary unique concavity 42A effectively overcoming the tension between the narrow open area along the surface of concavity 42A, effectively securing the section member 30A to book cover 10.

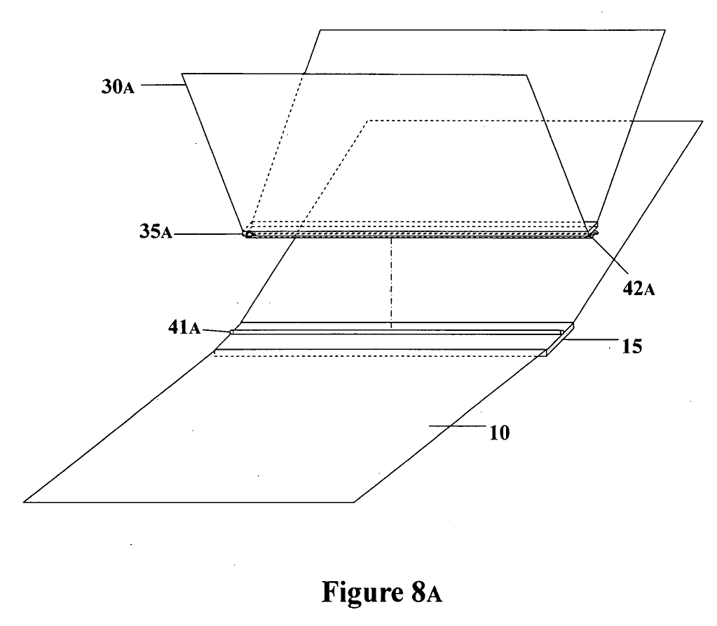

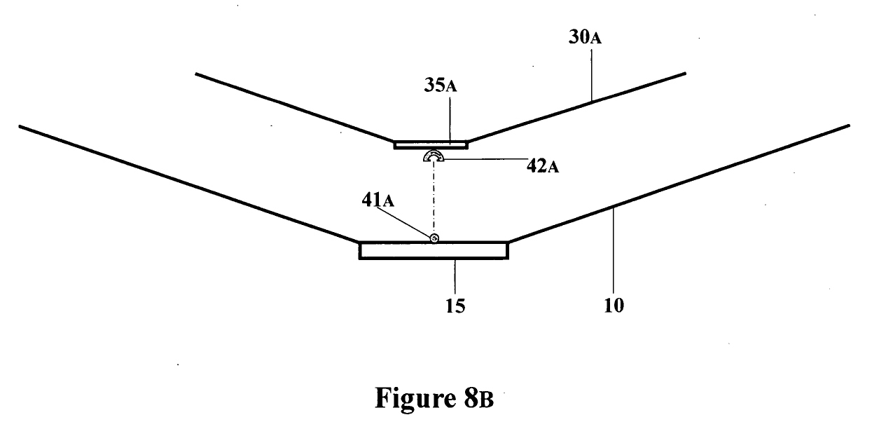

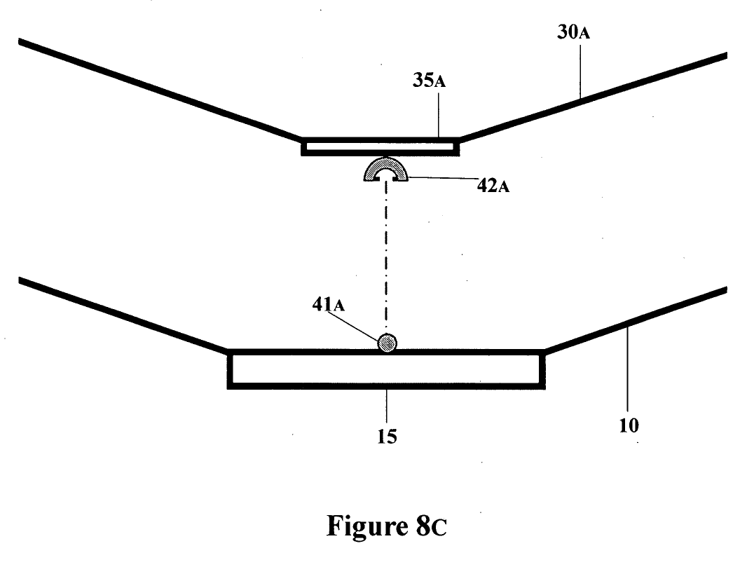

FIGS. 8A, 8B, and 8C depict another enforced tension-release groove mechanism between book cover 10 and section member 30A. In this embodiment, there is a unique concavity 42A along the exterior of the spine region 35A of the section member 30A. A complimentary convexity 41A is placed along the interior of the spine region 15 of the book cover 10. This arrangement will allow the section member 30A to attach to book cover 10 by applying force and inserting unique convexity 41A into the complimentary unique concavity 42A effectively overcoming the tension between the narrow open area along the surface of concavity 42A, effectively securing the section member 30A to book cover 10.

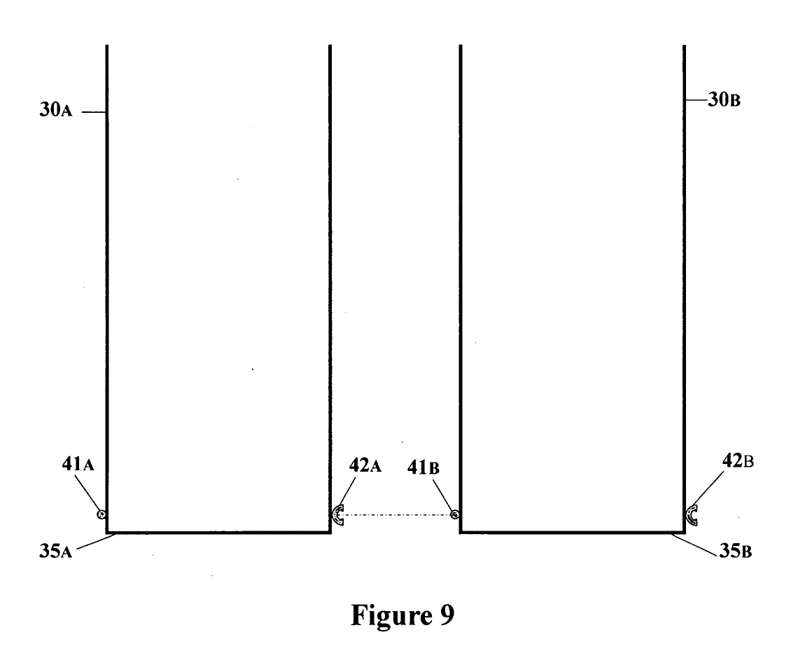

FIG. 9 depicts an additional enforced tension-release groove mechanism between section member 30A and section member 30B. Unique convexities 41A and 41B compliment the unique concavities 42A and 42B. In this embodiment, convexity 41B and concavity 42B are located on parallel planes near the perpendicular plane of the of the spine region 35B of section member 30B. In this embodiment, convexity 41A and concavity 42A are located on parallel planes near the perpendicular plane of the spine region 35A of section member 30A. This arrangement will allow the section member 30A to attach to section member 30B by applying force and inserting unique convexity 41B into the complimentary unique concavity 42A, effectively overcoming the tension between the narrow open areas along the surface of concavity 42A, effectively securing the section members 30A and 30B to each other.

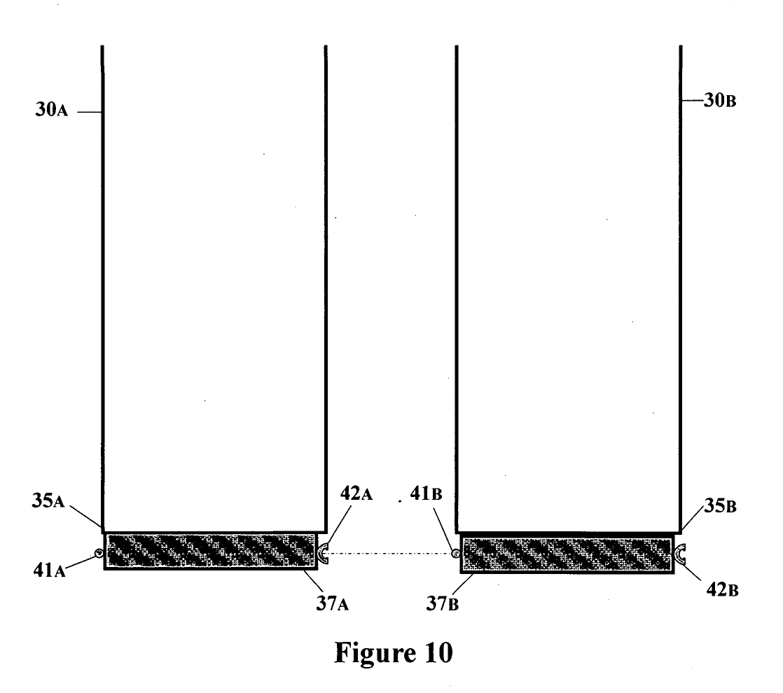

FIG. 10 depicts another tension-release groove mechanism between section member 30A and section member 30B, utilizing affixed elements 37A and 37B. Unique convexities 41A and 41B compliment the unique concavities 42A and 42B. In this embodiment, convexity 41B and concavity 42B are located on parallel planes of element 37B near the perpendicular plane of the spine region 35B of section member 30B. In this embodiment, convexity 41A and concavity 42A are located on parallel planes of element 37A near the perpendicular plane of the spine region 35A of section member 30A. This arrangement will allow the section member 30A to attach to section member 30B by applying force and inserting unique convexity 41B into the complimentary unique concavity 42A, effectively overcoming the tension between the narrow open areas along the surface of concavity 42A, effectively securing the section members 30A and 30B to each other.

One of the many uses of the present invention is for books that are traditionally bulky and heavy, and which may require updates and additional versions to be reprinted in an effort to contain the most current information. Sections of the book may be republished with the most up-to-date material. Users of the book may also choose to separate sections of the text from the whole by detaching the sections from the book cover. The sections may be removed by sliding and/or pulling the individually-bound section members from another section member and/or book cover.

As previously mentioned in the present disclosure, variations in the above embodiments include a plurality of the adjoining members described for each embodiment. Each of the above mechanisms depicted in a unique drawing is merely exemplary of the invention as described herein and claimed within the scope of the present application.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for supporting a printed matter, the device comprising:
two or more components of a printed matter; and
a sliding slot mechanism on each component to use for attachment to another component.

2. The system of claim 1, wherein the component is a section of the printed matter.

3. The system of claim 1, wherein the component is a cover for the printed matter.

4. The system of claim 1, wherein the components include a combination of sections of the printed matter and a cover.

5. The system of claim 1, wherein the mechanism includes complementary elements on each component.

6. The system of claim 5, wherein each component includes at least one set of complementary elements.

7. The system of claim 6, wherein the complementary components include tongue and groove.

8. The system of claim 6, wherein the complementary components include convexities and concavities.

9. The system of claim 6, wherein the complementary components include snap fit elements.

10. The system of claim 6, wherein the complementary components include a cavity.

11. A book with detachable sections, comprising:
a book cover;
individually bound sections containable within the book cover; and
a sliding slot mechanism on the book cover and/or the sections to use for attachment to the cover and/or another section.

12. The book of claim 11, wherein the mechanism includes complementary elements on the cover and sections.

13. The book of claim 11, wherein the cover and sections include at least one set of complementary elements.

14. The book of claim 13, wherein the complementary components include tongue and groove.

15. The book of claim 13, wherein the complementary components include convexities and concavities.

16. The book of claim 13, wherein the complementary components include snap fit elements.

17. The book of claim 13, wherein the complementary components include a cavity.

18. A method of maintaining various components of a printed matter together, the method comprising:
attaching the components to each other through use of complementary elements on each component through a sliding slot mechanism.

19. The method of claim 18, wherein the component is a section of the printed matter.

20. The method of claim 18, wherein the component is a cover for the printed matter.
